(19) United States
(12) Patent Application Publication
(10) Pub. No.: US 2026/0339249 A1
(43) Pub. Date: Oct. 29, 2026

(54) CHARGE ELIMINATING APPARATUS, IMAGE FORMING APPARATUS, AND CHARGE ADJUSTING APPARATUS

(71) Applicant: CANON KABUSHIKI KAISHA, Tokyo (JP)

(72) Inventors: YASUSHI TAKEUCHI, Ibaraki (JP); YUTAKA KAKEHI, Chiba (JP); RYOSUKE TSURUGA, Chiba (JP); YASUHARU CHIYODA, Chiba (JP)

(21) Appl. No.: 19/700,609

(22) Filed: Jun. 8, 2026

Related U.S. Application Data
(63) Continuation of application No. PCT/JP2024/080206, filed on Nov. 25, 2024.

(30) Foreign Application Priority Data
Dec. 15, 2023 (JP) 2023-212350

(51) Int. Cl. G03G 15/00

(52) U.S. Cl. CPC G03G 15/5004; G03G 15/5029; G03G 15/6573; G03G 2215/00447; G03G 2215/00493

(57) ABSTRACT

A charge eliminating apparatus includes a charge eliminating member for eliminating charge of a sheet, and a voltage applying portion for applying a voltage to the charge eliminating member. A controller is configured such that, when the charge of the sheet on which an image is formed only on one side is eliminated, the voltage applied by the voltage applying portion to the charge eliminating member is a first voltage, and when the charge of the sheet on which images are formed on both sides is eliminated, the voltage applied by the voltage applying portion to the charge eliminating member is a second voltage, the controller sets a value of the second voltage to be different from a value of the first voltage.

### TECHNICAL FIELD

The present invention relates to a charge eliminating apparatus which eliminates charge of a sheet, an image forming system which forms an image on the sheet, and a charge adjusting apparatus which adjusts a charged state of the sheet.

### BACKGROUND ART

In Japanese Patent Application Laid-Open No. 2019-167169, a charge eliminating apparatus, which eliminates charge of a sheet using a charge eliminating roll, which contacts the sheet, (charge eliminator of contact type) and a charge eliminator of non-contact type of corotron type, is disclosed.

### SUMMARY OF THE INVENTION

### PROBLEM TO BE SOLVED BY THE INVENTION

In Japanese Patent Application Laid-Open No. 2019-167169 described above, there is no description on changing a setting value for a voltage to be applied to the charge eliminating roll depending on whether the image forming apparatus performs single-side printing or double-side printing. However, as a result of studies conducted by the present inventors, it is found that there is a case in which the values of the voltage suitable for performing charge eliminating of the sheet or adjustment of the charged state of the sheet are different between the sheet on which the single-side printing has been performed and the sheet on which the double-side printing has been performed.

Therefore, an object of the present invention is to provide a charge eliminating apparatus, an image forming system, and a charge adjusting apparatus which are more appropriately capable of performing charge eliminating of a sheet or adjustment of a charged state of the sheet.

### MEANS FOR SOLVING THE PROBLEM

An aspect of the present invention is a charge eliminating apparatus comprising: a charge eliminating member configured to eliminate charge of a sheet; a voltage applying portion configured to apply a voltage to the charge eliminating member; and a controller configured such that, when the charge of the sheet on which an image is formed only on one side is eliminated, the voltage applied by the voltage applying portion to the charge eliminating member is a first voltage, and when the charge of the sheet on which images are formed on both sides is eliminated, the voltage applied by the voltage applying portion to the charge eliminating member is a second voltage, the controller sets a value of the second voltage to be different from a value of the first voltage.

Another aspect of the present invention is a charge adjusting apparatus comprising: a charge supplying member configured to supply charge to a sheet; a voltage applying portion configured to apply a voltage to the charge supplying member; and a controller configured such that, when a charged state of the sheet on which an image is formed only on one side is adjusted, the voltage applied by the voltage applying portion to the charge supplying member is a first voltage, and when the charged state of the sheet on which images are formed on both sides is adjusted, the voltage applied by the voltage applying portion to the charge supplying member is a second voltage, the controller sets a value of the second voltage to be different from a value of the first voltage.

### EFFECT OF THE INVENTION

According to the present invention, it becomes possible to provide a charge eliminating apparatus, an image forming system, and a charge adjusting apparatus which are more appropriately capable of performing charge eliminating of a sheet or adjustment of a charged state of the sheet.

### BRIEF DESCRIPTION OF THE DRAWINGS

FIG. 1 is an outline view of an image forming system according to an Embodiment 1.

FIG. 2 is an outline view of a charge eliminating apparatus according to the Embodiment 1.

FIG. 3 is an outline view of a conveyance guide according to the Embodiment 1.

FIG. 4 is an outline view of an operating portion for charge eliminating according to the Embodiment 1.

FIG. 5 is an outline view illustrating a charged state of a sheet, on which single-side printing is performed, before and after passing through a charge eliminating nip.

FIG. 6 is an outline view illustrating the charged state of the sheet on which double-side printing has been performed before passing through a secondary transfer portion.

FIG. 7 is a view showing a relationship between a thickness of the sheet and an appropriate value for a charge eliminating voltage.

FIG. 8 is a block diagram of a control system according to the Embodiment 1.

FIG. 9 is a flowchart showing a control method according to the Embodiment 1.

FIG. 10 is a flowchart showing a control method according to an Embodiment 2.

### EMBODIMENTS FOR CARRYING OUT THE INVENTION

Hereinafter, Embodiments according to the present disclosure will be described with reference to the drawings.

### Embodiment 1

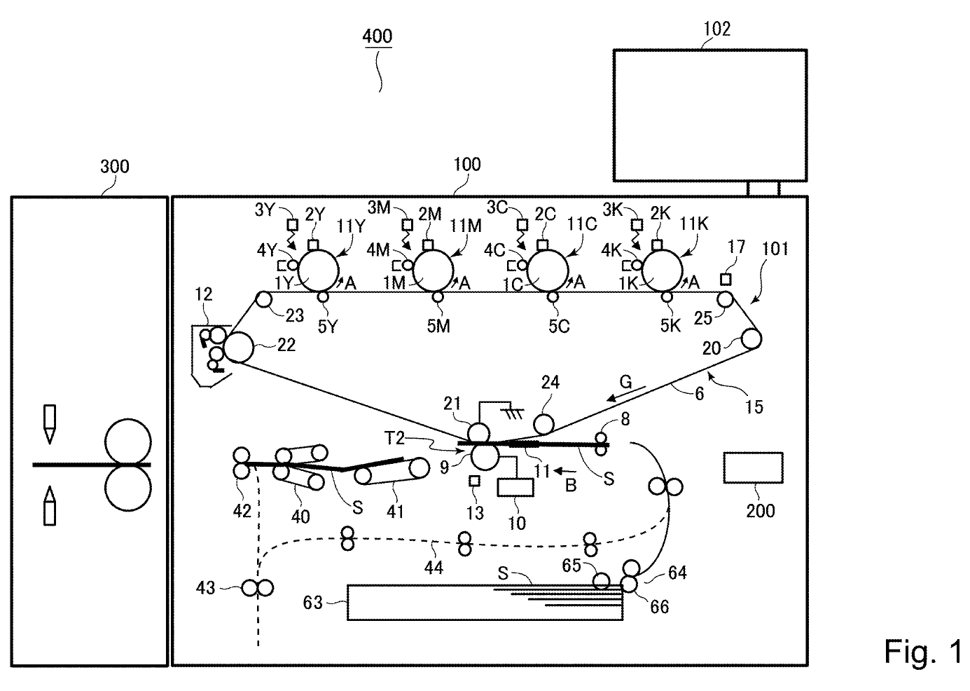

In FIG. 1, an outline view of an image forming system 400 according to an Embodiment 1 is illustrated. The image forming system 400 includes an image forming apparatus 100 (printer) and a charge eliminating apparatus 300, which is connected to the image forming apparatus 100. The image forming system 400 forms an image on a sheet S and discharges the sheet S as a product (printed product). As the sheet S, which is a recording material (recording medium), a variety of sheet material of different sizes and material may be used, for example, a paper such as a plain paper and a thick paper, sheet material onto which surface treatment is applied such as a coated paper, special shaped sheet material such as an envelope and an index paper, sheet material made of plastic, a cloth, etc. Examples of the sheet material made of plastic include a synthetic paper whose main raw material is synthetic resin and a sheet for an overhead projector (OHT).

The charge eliminating apparatus 300 is an apparatus (static eliminator) which eliminates (reduces) electric charge (charge) of the sheet S discharged from the image forming system 400. The charge eliminating apparatus 300 may be referred to as a charge adjusting apparatus for adjusting a charged state of the sheet S discharged from the image forming system 400. The charge eliminating apparatus 300 may be an apparatus which is provided with functions other than the charge eliminating function (e.g., a decurling function to correct curling of the sheet S). In addition, the charge eliminating apparatus 300 in the present Embodiment is disposed as an apparatus independent of the image forming apparatus 100, however, the charge eliminating apparatus 300 may be incorporated in a housing of the image forming apparatus 100.

The image forming system 400 may include an optional apparatus other than the charge eliminating apparatus 300. Examples of the optional apparatus include a high-capacity feeding apparatus (optional feeder), which supplies the sheet S to the image forming apparatus 100, and a sheet processing apparatus (finisher), which applies a processing such as a binding processing to the sheets S on which the images have been formed by the image forming apparatus 100.

### Image forming apparatus

An outline configuration of the image forming apparatus 100 is illustrated in FIG. 1. The image forming apparatus 100 includes an image forming portion 101, which is an electrophotographic mechanism of intermediary transfer type. The image forming portion 101 includes four process units 11Y, 11M, 11C, and 11K, which include photosensitive drums 1Y, 1M, 1C, and 1K, respectively, and a transfer unit 15, which includes an intermediary transfer belt 6 and a secondary transfer roller 9.

Each process unit includes the photosensitive drum as an image bearing member (latent image bearing member), a charging apparatus, an exposure device, and a developing device as a process portion which acts onto the photosensitive drum to perform each process in electrophotographic processes. In other words, the process unit 11Y includes the photosensitive drum 1Y, a charging device 2Y, an exposure device 3Y and a developing device 4Y. The process unit 11M includes the photosensitive drum 1M, a charging device 2M, an exposure device 3M and a developing device 4M. The process unit 11C includes the photosensitive drum 1C, a charging device 2C, an exposure device 3C and a developing device 4C. The process unit 11K includes the photosensitive drum 1K, a charging device 2K, an exposure device 3K and a developing device 4K.

The respective photosensitive drums 1Y, 1M, 1C, and 1K are rotationally driven in predetermined rotational directions A, respectively. The process units 11Y, 11M, 11C, and 11K have substantially the same configurations, except that toner as developer accommodated in the developing devices 4Y, 4M, 4C, and 4K is different from each other.

The transfer unit 15 includes the intermediary transfer belt 6 as an intermediary transfer member, the secondary transfer roller 9 as a transfer means (secondary transfer means), primary transfer rollers 5Y, 5M, 5C, and 5K, a plurality of rollers 20, 21, 22, 23, 24, and 25 and a belt cleaner 12. The intermediary transfer belt 6 is stretched over the plurality of rollers 20, 21, 22, 23, 24, and 25. The primary transfer rollers 5Y, 5M, 5C, and 5K are disposed on an inner surface side of the intermediary transfer belt 6 and at positions corresponding to the photosensitive drums 1Y, 1M, 1C, and 1K, respectively. Between the primary transfer rollers 5Y, 5M, 5C, and 5K and the corresponding photosensitive drums 1Y, 1M, 1C, and 1K, primary transfer portions are formed. The roller 20 is a tension roller which applies an appropriate tensile force to the intermediary transfer belt 6. The roller 22 is a driving roller which rotationally drives the intermediary transfer belt 6 in a predetermined rotational direction G. The secondary transfer roller 9 contacts an outer surface of the intermediary transfer belt 6, and is disposed so as to nip the intermediary transfer belt 6 together with the opposite roller 21 (secondary transfer opposite roller). As a nip portion between the secondary transfer roller 9 and the intermediary transfer belt 6, a secondary transfer portion T2 as a transfer portion, in which a toner image is transferred to the sheet S, is formed.

The image forming apparatus 100 is provided with a transfer power source 10 as a voltage applying means to form a bias electric field in the secondary transfer portion T2 for performing the transfer of the toner image. In the present Embodiment, the secondary transfer roller 9, which is an outer roller of the secondary transfer portion T2, is electrically connected to the transfer power source 10, and a predetermined transfer voltage is applied thereto from the transfer power source 10. The transfer voltage is a voltage having an opposite polarity to a normal charging polarity of the toner, which is used for an image formation. On the other hand, the opposite roller 21, which is an inner roller of the secondary transfer portion T2, is electrically connected to a ground potential GND (metal frame, etc.) of the image forming apparatus 100. Incidentally, the inner roller of the secondary transfer portion T2 may be connected to the transfer power source 10, and the outer roller of the secondary transfer portion T2 may be connected to the ground potential GND. In this case, a transfer voltage having the same polarity as the normal charging polarity of the toner is applied to the inner roller.

The image forming apparatus 100 further includes an accommodating portion 63 (storage, cassette), which accommodates the sheet S, a feeding unit 64, which feeds the sheet S, and a registration roller 8, which performs registration (positional alignment) of the sheet S. In addition, the image forming apparatus 100 includes a pre fixing conveyance device 41, which conveys the sheet S which has passed through the secondary transfer portion T2, a fixing device 40, which fixes the toner image to the sheet S, and a discharging roller pair 42 as a discharging unit, which discharges the sheet S outside the image forming apparatus 100.

The feeding unit 64 includes, for example, a pickup roller 65, which picks up an uppermost sheet S from the accommodating portion 63 in a sheet feeding direction, and a separating roller pair 66, which conveys the sheet S while separating the picked up sheets S one at a time. The separating roller pair 66 includes a conveyance roller, which feeds the uppermost sheet S in the sheet feeding direction, and a separating roller, which is in contact with the conveyance roller and forms a separation nip together with the conveyance roller. The separating roller prevents a multiple feeding of the sheets S by preventing the sheets S other than the uppermost sheet S from being passed through the separation nip by applying frictional force to the sheet S in the separation nip. The separating roller is an example of a separating member which separates the sheets S, and for example, an elastic member having a pad shape (rubber pad) may be used as the separating member.

The fixing device 40 is a device of heat fixing type, which includes a fixing nip and in which the toner image on the sheet S is heated while the sheet S is nipped and conveyed by the fixing nip. The fixing device 40 includes a heating member, which contacts a surface of the sheet S on which the toner image has been formed, a pressing member, which forms the fixing nip together with the heating member, and a heat source, which heats the heating member. For the heating member and the pressing member, for example, a belt member which is stretched over a plurality of rollers or a roller member which has rigidity may be used. For the heat source, for example, a halogen lamp or an induction heating mechanism of IH type may be used.

In addition, the image forming apparatus 100 is provided with a user operating portion 102, which is a user interface of the image forming system 400. The user operating portion 102 includes a display portion which displays information to a user such as a liquid crystal panel and an input portion which receives input of information from a user such as a physical button and a touch panel function of the liquid crystal panel. A user can set, through operation of the user operating portion 102, setting information and execution conditions for image forming operation to the image forming system 400. The setting information is, for example, attribute information of the sheet S accommodated in the accommodating portion 63 such as a size, material, and brand name. The execution conditions for image forming operation include, for example, a value of the transfer voltage.

Upon an execution instruction of the image formation being input from a user, a control portion of the image forming apparatus 100 starts an image forming job, which is a series of tasks in which, while the sheet S is conveyed one at a time, the image is formed thereon and the product is output. Hereinafter, a series of operations in which the image is formed for one sheet of the sheet S by the image forming apparatus 100 is referred to as the image forming operation. The image forming job includes the image forming operation for at least one sheet of the sheet S.

In the image forming operation, in the process units 11Y, 11M, 11C, and 11K, the toner images of the respective colors are formed. Specifically, the photosensitive drums 1Y, 1M, 1C, and 1K are rotationally driven, and the charging devices 2Y, 2M, 2C, and 2K uniformly charge surfaces of the photosensitive drums 1Y, 1M, 1C, and 1K, respectively. The exposure devices 3Y, 3M, 3C, and 3K expose the photosensitive drums 1Y, 1M, 1C, and 1K based on image information, which is input together with the execution instruction, and the electrostatic latent images are formed on the surfaces of the photosensitive drums 1Y, 1M, 1C, and 1K, respectively. The developing devices 4Y, 4M, 4C, and 4K supply the toner of yellow, magenta, cyan, and black to the photosensitive drums 1Y, 1M, 1C, and 1K to develop the electrostatic latent images into the toner images of the respective colors, respectively.

Incidentally, in the present Embodiment, a reverse developing type is used. That is, after the charging device charges the surface of the photosensitive drum to the same polarity as the normal charging polarity of the toner, potential of an exposed area exposed by the exposure device is attenuated, and the toner is adhered to the exposed area upon the development.

The toner images, which has been formed in the respective process units 11Y, 11M, 11C, and 11K, are primarily transferred from the photosensitive drums 1Y, 1M, 1C, and 1K to the intermediary transfer belt 6 in the primary transfer portion. To the primary transfer rollers 5Y, 5M, 5C, and 5K, the transfer voltage having the opposite polarity to the normal charging polarity of the toner is applied through a constant voltage control.

In the present Embodiment, the primary transfer rollers 5Y, 5M, 5C, and 5K are electroconductive rollers, which include a core metal and a conductive elastic layer formed on an outer periphery side of the core metal. The elastic layer is formed of, for example, ion-conductive foam rubber. The ion-conductive foam rubber is foam rubber material in which a conductive agent, which manifests ion conductivity, is dispersed. For the conductive agent and the foam rubber material, known material for the transfer roller may be used. For each of the primary transfer rollers, for example, a roller which has an outer diameter of 15 through 20 mm and a resistance value of 1E+5 through 1E+8 Ω when a voltage of 2 kV is applied an under environmental condition of 23 °C and 50%RH may be suitably used.

The intermediary transfer belt 6 is rotationally driven at a predetermined peripheral speed (process speed), which is equal to peripheral speeds of the photosensitive drums 1Y, 1M, 1C, and 1K. In the present Embodiment, the peripheral speed is 150 through 470 mm/sec. Along with the rotation of the intermediary transfer belt 6, by the toner image of another color being transferred over the toner image, which has been transferred by the primary transfer portion on an upstream side, a full-color toner image is formed on the intermediary transfer belt 6. The full-color toner image is carried by the intermediary transfer belt 6, and conveyed toward the secondary transfer portion T2.

In parallel with the toner image formation in the image forming portion 101, the feeding unit 64 feeds the sheet S one at a time toward the image forming portion 101. The fed sheet S is conveyed, by the registration roller 8, to the secondary transfer portion T2 in synchronization with a timing when the toner image on the intermediary transfer belt 6 is conveyed to the secondary transfer portion T2. Then, in the secondary transfer portion T2, the toner image is transferred (secondarily transferred) from the intermediary transfer belt 6 to the sheet S.

In the present Embodiment, the secondary transfer roller 9 is a conductive roller which includes a core metal and a conductive elastic layer formed on an outer periphery side of the core metal. The elastic layer is formed of, for example, ion-conductive foam rubber. The ion-conductive foam rubber is foam rubber material in which a conductive agent, which manifests ion conductivity, is dispersed. For the conductive agent and the foam rubber material, known material for the transfer roller may be used. For the secondary transfer roller 9, for example, a roller which has an outer diameter of 20 through 25 mm and a resistance value of 1E+5 through 1E+8 Ω when a voltage of 2 kV is applied under an environmental condition of 23 °C and 50%RH may be suitably used.

In addition, the opposite roller 21 is a conductive roller which includes a core metal and an elastic layer of electroconductive foam rubber formed on an outer periphery side of the core metal. The electroconductive foam rubber is foam rubber material in which a conductive agent, which manifests electron conductivity, is dispersed. For the conductive agent and the foam rubber material, known material for the transfer roller may be used. For the opposite roller 21, for example, a roller which has an outer diameter of 20 through 22 mm and a resistance value of 1E+5 through 1E+8 Ω when a voltage of 50V is applied under an environmental condition of 23 °C and 50% RH may be suitably used.

Upon the secondary transfer, to the secondary transfer roller 9, the transfer voltage having the opposite polarity to the normal charging polarity of the toner is applied from the transfer power source 10 through the constant voltage control. The transfer voltage is, for example, +1 through +7 kV, and is automatically adjusted so that current of +40 through +120 μA flows from the secondary transfer roller 9 to the opposite roller 21. By the application of the transfer voltage, the bias electric field is formed in the secondary transfer portion T2, in which potential of the secondary transfer roller 9 becomes the opposite polarity to the normal charging polarity of the toner with respect to the intermediary transfer belt 6. By this bias electric field, electrostatic force in a direction approaching to the secondary transfer roller 9 is acted onto the toner on the intermediary transfer belt 6. Then, by the toner being transferred from the intermediary transfer belt 6 to the sheet S passing through the secondary transfer portion T2, the toner image is transferred to the sheet S.

Incidentally, immediately before the secondary transfer portion T2, a conveyance guide 11 for improving positioning accuracy of the sheet S with respect to the intermediary transfer belt 6 is provided. In addition, transfer residual toner, which remains on the intermediary transfer belt 6 without being transferred to the sheet S, is collected by the belt cleaner 12, and reused for the image formation.

The sheet S, which has passed through the secondary transfer portion T2, is conveyed to the fixing device 40 by the pre fixing conveyance device 41, and the toner image is subjected to a fixing process by the fixing device 40. The fixing process is a process in which the toner image on the sheet S is heated and pressed while the sheet S is nipped and conveyed in the nip portion of the fixing device 40. The pre fixing conveyance device 41 carries and conveys the sheet S on an endless rubber belt, for example. For the rubber belt, ethylene propylene diene rubber (EPDM) having a width of 100 through 110 mm and a thickness of 1 through 3 mm may be used. In addition, the rubber belt has holes having a diameter of 3 through 7 mm, and by generating negative pressure inside the rubber belt using a fan, the sheet S can be stably carried on the rubber belt.

In a case of the image forming operation in which the image is formed only on one side of the sheet S (single-side printing), the sheet S which has passed through the fixing device 40 is discharged by the discharging roller pair 42 toward the charge eliminating apparatus 300.

In a case of the image forming operation in which the images are formed on both sides of the sheet S (double-side printing), a reversing conveyance of the sheet S, which has passed through the fixing device 40 in the state in which the toner image had been transferred onto a first surface (front surface) thereof, is performed. The image forming apparatus 100 includes a reversing portion 43 which reverses the sheet S, and a double-side conveyance portion 44 for conveying the reversed sheet S toward the secondary transfer portion T2 again. The reversing portion 43 is a roller pair which is capable of a forward rotation and a reverse rotation. The reversing portion 43 switches back the sheet S, and feeds the sheet S into the double-side conveyance portion 44. And the sheet S in a state in which the first surface (front surface) and a second surface (back surface) are reversed is conveyed to the secondary transfer portion T2 again via the double-side conveyance portion 44, and the toner image is transferred onto the back surface of the sheet S. And the sheet S which has passed through the fixing device 40 in the state in which the toner image has been transferred onto the back surface thereof is discharged toward the charge eliminating apparatus 300 by the discharging roller pair 42.

The image forming portion 101 of intermediary transfer type described above is an example of an image forming means which forms the image on the sheet S, and the image forming means may be an electrophotographic unit of direct transfer type, for example. In this case, a toner image formed on a photosensitive drum as an image bearing member is directly transferred, in a transfer nip (transfer portion) in which the photosensitive drum and a transfer roller are opposite to each other, from the photosensitive drum to a sheet S. In the transfer nip, a bias electric field, in which a potential of the transfer roller becomes an opposite polarity to a normal charging polarity of toner with respect to the photosensitive drum, is formed.

### Charge eliminating apparatus

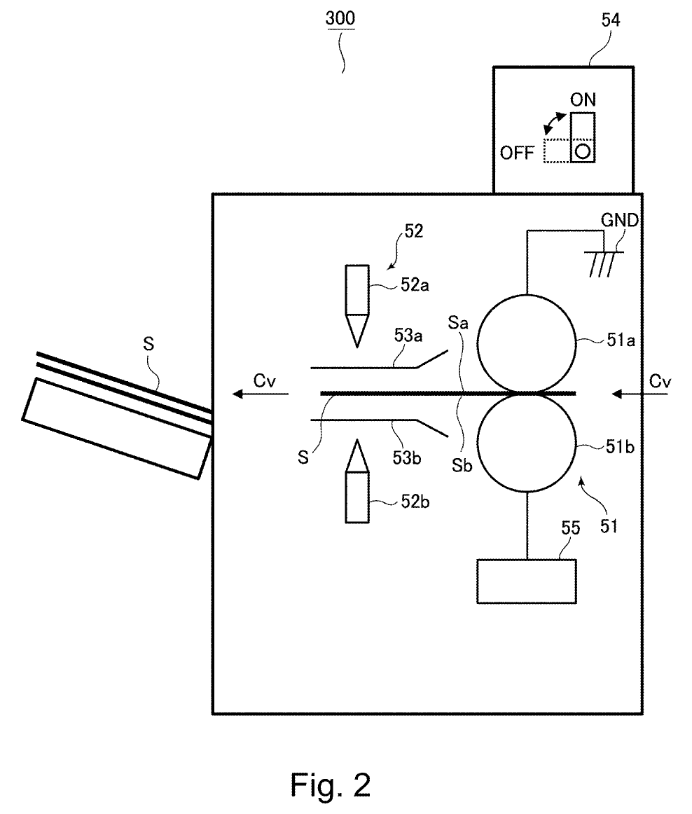

FIG. 2 is an outline view of the charge eliminating apparatus 300 in the Embodiment 1. In the present Embodiment, the charge eliminating apparatus 300 is connected to a downstream side of the image forming apparatus 100 in a sheet conveyance direction Cv. The charge eliminating apparatus 300 performs, while receiving the sheet S, on which the image has been formed by the image forming apparatus 100, and conveying the sheet S in the sheet conveyance direction Cv, charge eliminating of the sheet S (reducing electrostatic charge on the sheet surface). By performing the charge eliminating of the sheet S, it becomes possible to prevent the sheets, which are discharged from the image forming system 400 and stacked, from sticking to each other due to electrostatic adsorption force, and deterioration in alignment of the sheets due to the sticking between the sheets. The charge eliminating apparatus 300 is provided with a charge eliminating roller pair 51 as a charge eliminator of contact type and an ionizer portion 52 as a charge eliminator of non-contact type.

The charge eliminating roller pair 51 includes a charge eliminating opposing roller 51a, which contacts a first surface Sa of the sheet S, and a charge eliminating roller 51b, which contacts a second surface Sb opposite to the first surface Sa of the sheet S. The charge eliminating roller 51b is a charge eliminating member of contact type, which contacts the sheet S to be conveyed thereto and eliminates the charge of the sheet S. The charge eliminating opposing roller 51a is brought into contact with the charge eliminating roller 51b, and as a nip portion between the charge eliminating roller 51b and the charge eliminating opposing roller 51a, a charge eliminating nip is formed. The charge eliminating roller pair 51 performs the charge eliminating of the sheet S while nipping and conveying the sheet S with the charge eliminating nip.

The charge eliminating opposing roller 51a is connected to the ground potential GND. The charge eliminating opposing roller 51a is electrically connected to, for example, a metal frame of the charge eliminating apparatus 300, and is electrically grounded. The charge eliminating roller 51b is connected to a high voltage power source 55. The high voltage power source 55 is a voltage applying means, which applies a voltage (charge eliminating voltage) for performing the charge eliminating of the sheet S to the charge eliminating roller 51b. In the present Embodiment, the high voltage power source 55 applies a direct current voltage having an opposite polarity to the transfer voltage, which the transfer power source 10 applies to the secondary transfer roller 9, to the charge eliminating roller 51b.

Incidentally, it may be configured that the charge eliminating roller 51b is disposed so as to contact the first surface Sa of the sheet S and the charge eliminating opposing roller 51a is disposed so as to contact the second surface Sb of the sheet S. In that case, the voltage applied to the charge eliminating roller 51b becomes the opposite polarity to the voltage, which is applied to the charge eliminating roller 51b in the present Embodiment (i.e., the same polarity as the transfer voltage).

In the present Embodiment, the charge eliminating roller 51b is an electroconductive roller which includes a core metal and an electroconductive elastic layer formed on an outer periphery side of the core metal. The elastic layer is formed of, for example, ion-conductive foam rubber. The ion-conductive foam rubber is foam rubber material in which a conductive agent, which manifests ion conductivity, is dispersed. For the conductive agent and the foam rubber material, known material may be used. For the charge eliminating roller 51b, for example, a roller which has an outer diameter of 20 through 25 mm and a resistance value of 1E+5 through 1E+8 Ω when a voltage of 2kV is applied under an environmental condition of 23 °C and 50%RH may be suitably used. The charge eliminating opposing roller 51a is made of stainless steel (SUS), and, for the charge eliminating opposing roller 51a, a roller which has an outer diameter of 20 through 25 mm is used. Incidentally, as the charge eliminating roller 51b, a roller formed of metal such as stainless steel may be used.

The ionizer portion 52 includes a first ionizer 52a facing the first surface of the sheet S and a second ionizer 52b facing the second surface of the sheet S. Each of the first ionizer 52a and the second ionizer 52b includes an electrode needle, and by applying a voltage to the electrode needle, corona electric discharge is generated from a tip of the needle, causing air around the tip of the needle to be ionized. Then, by the generated ions neutralizing the charge on the sheet surface, the charge of the sheet S is eliminated.

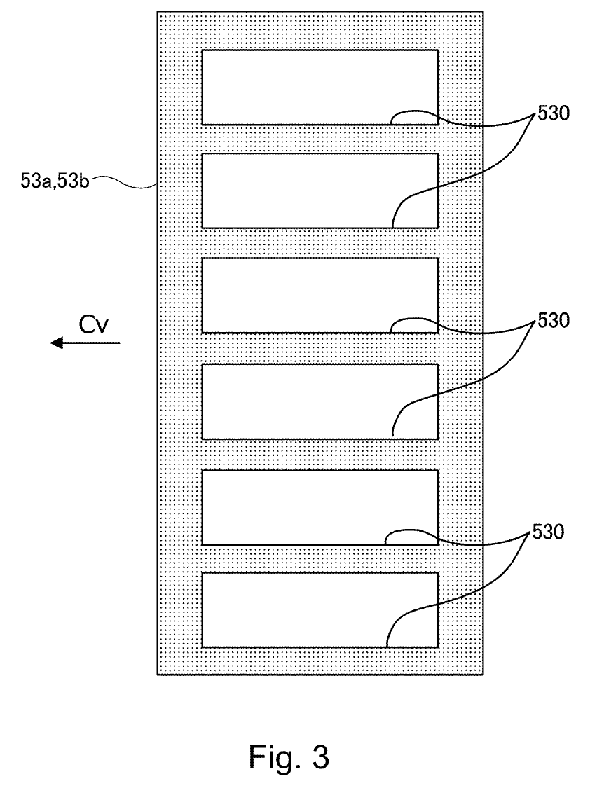

As the ionizer portion 52 in the present Embodiment, bar type ionizers IZS40 (manufactured by SMC Corporation) are disposed above and below a sheet conveyance path as the first ionizer 52a and the second ionizer 52b. It is configured that conveyance guides 53a and 53b, which form the sheet conveyance path in the ionizer portion 52, are made of, for example, resin synthesized from PC (polycarbonate) and ABS (acrylonitrile-butadiene-styrene). Volume resistivities of the conveyance guides 53a and 53b are, for example, 1 × 10¹⁴ Ω cm. Furthermore, as shown in FIG. 3, to each of the conveyance guides 53a and 53b, a plurality of holes 530 in order for the ions emitted from the first ionizer 52a and the second ionizer 52b not to be physically shielded are formed. The plurality of holes 530 are disposed side by side in a sheet widthwise direction, which is perpendicular to the sheet conveyance direction Cv.

The first ionizer 52a and the second ionizer 52b described above are examples of the charge eliminator of non-contact type, and other charge eliminators of non-contact type may be used. For example, a charge eliminator of corotron type or scorotron type, which eliminates charge of a sheet by corona electric discharge from an electric discharging wire, may be used. In addition, it is not necessary to provide the charge eliminator of non-contact type on both sides of the conveyance path but, for example, it may be a configuration in which the charge eliminating apparatus 300 includes only the first ionizer 52a as the charge eliminator of non-contact type. In addition, in a case in which the charge of the sheet S can be sufficiently eliminated by the charge eliminating roller 51b, the charge eliminator of non-contact type may be omitted.

For the sheet S conveyed from the image forming apparatus 100 to the charge eliminating apparatus 300, firstly, most of the charge thereof is removed (roughly removed) by the charge eliminating nip of the charge eliminating roller pair 51. Specifically, the charge eliminating voltage is set to the opposite polarity to the transfer voltage, which is applied to the secondary transfer roller 9. A value of the charge eliminating voltage is set in a range of -1 kV through -6 kV.

In the secondary transfer portion T2 (FIG. 1), normally, the sheet S is charged in a manner that the first surface Sa of the sheet S, which has contacted the intermediary transfer belt 6, becomes negative polarity, and the second surface Sb, which has contacted the secondary transfer roller 9, becomes positive polarity. By the charge eliminating voltage of the opposite polarity to the transfer voltage being applied to the charge eliminating roller 51b, between the charge eliminating roller 51b and the charge eliminating opposing roller 51a, a current flows so that positive charge is supplied to the first surface Sa of the sheet S and negative charge is supplied to the second surface Sb. In this manner, by the current flowing via the sheet S in the charge eliminating nip by the application of the charge eliminating voltage to the charge eliminating roller 51b, an electrification charge amount of the sheet S, which is an amount of charge borne on the first surface Sa and the second surface Sb of the sheet S, is reduced.

The sheet S, which has passed through the charge eliminating roller pair 51, is further subjected to charge eliminating in the ionizer portion 52. Specifically, by the ions being irradiated from the first ionizer 52a and the second ionizer 52b, remaining charge on the first surface Sa and the second surface Sb of the sheet S is neutralized, and the electrification charge amount of the sheet S is further reduced. The sheet S which has passed through the ionizer portion 52 is discharged outside the charge eliminating apparatus 300.

Incidentally, the electrification charge amount of the sheet S and a surface potential of the sheet S are usually proportional. In addition, the electrification charge amount of the sheet S may be expressed as an amount of charge per unit area of the sheet surface (surface charge density). Therefore, the "electrification charge amount" of the sheet S in the following description may be replaced to the surface potential of the sheet S or the surface charge density of the sheet S.

### Charge eliminating voltage adjusting switch

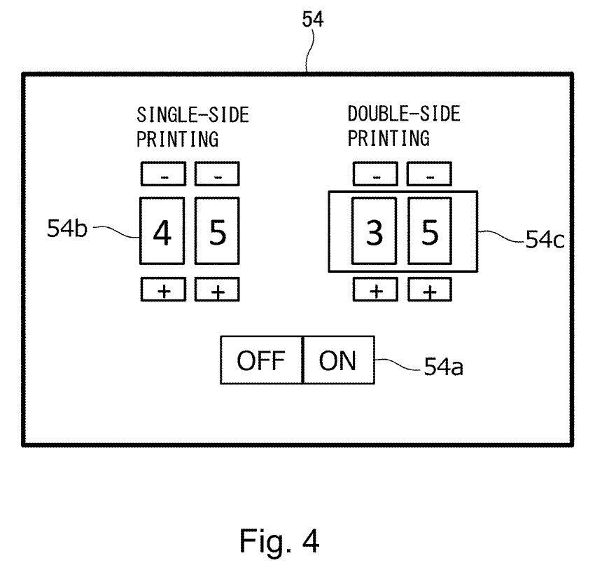

The charge eliminating apparatus 300 is provided with the operating portion for charge eliminating 54 through which operation to change operating conditions for the charge eliminating apparatus 300 is possible. In FIG. 4, an enlarged view of the operating portion for charge eliminating 54 is shown. The operating portion for charge eliminating 54 is an example of an input means (setting means) which allows a user to input (set) the value of the voltage to be applied to the charge eliminating roller 51b (charge eliminating member) by the high voltage power source 55 (voltage applying means).

The operating portion for charge eliminating 54 includes a changeover switch 54a and voltage adjusting switches 54b and 54c. By operating the changeover switch 54a, a user can switch between output (ON) and stop outputting (OFF) of the charge eliminating voltage by the high voltage power source 55 (FIG. 2), which applies the charge eliminating voltage to the charge eliminating roller 51b. The voltage adjusting switches 54b and 54c allow a user to adjust the value of the charge eliminating voltage.

The value of the charge eliminating voltage may be fixed at values set in advance correspondingly to categories of the sheet S. For example, in a case of a plastic film or a synthetic paper, it is known that it is likely for those sheets to be dielectrically polarized more strongly in the secondary transfer portion than a plain paper, and for the electrification charge amount of the sheet S to become larger. Therefore, in a case in which the plastic film or the synthetic paper is used as the sheet S, it may be considered that, so as the charge eliminating voltage to be set to a higher voltage (so as an absolute value thereof to be set to be larger) than a case in which the plain paper is used as the sheet S, the values of the charge eliminating voltage are set in advance correspondingly to the categories of the sheet S. However, even for the sheet S in the same category, there are cases in which an appropriate value for the charge eliminating voltage varies due to a difference in electric resistance and a difference in a thickness of the sheet S caused by a difference in specific material, a difference in an environment condition of an environment in which the charge eliminating apparatus 300 is installed, etc. Therefore, in the present Embodiment, it is configured that the value of the charge eliminating voltage is adjustable.

In the present Embodiment, as a setting for the charge eliminating voltage, two types of voltage values, which are a voltage value for the single-side printing (referred to as a first charge eliminating voltage) and a voltage value for the double-side printing (referred to as a second charge eliminating voltage), can be set. The first charge eliminating voltage (a first voltage) is a charge eliminating voltage which is applied to the charge eliminating roller 51b in a case in which the image forming system 400 executes the image forming job, in which the image is formed only on one side of the sheet (single-side printing job). The second charge eliminating voltage (a second voltage) is a charge eliminating voltage which is applied to the charge eliminating roller 51b in a case in which the image forming system 400 executes the image forming job in which the images are formed on both sides of the sheet (double-side printing job).

One of the voltage adjusting switches 54b is a switch for a user to set (input) the value of the first charge eliminating voltage. The other voltage adjusting switches 54c is a switch for a user to set (input) the value of the second charge eliminating voltage. For the first charge eliminating voltage and the second charge eliminating voltage, values different from each other may be input. This is because, as described below, a value suitable for performing the charge eliminating of the sheet S (referred to as an appropriate value for the charge eliminating voltage) may be different between the case in which the charge of the sheet S on which the single-side printing has been performed is eliminated (upon the single-side printing) and the case in which the charge of the sheet S on which the double-side printing has been performed is eliminated (upon the double-side printing).

Each of the voltage adjusting switches 54b and 54c in the present Embodiment includes a display portion which displays the value of the charge eliminating voltage (the first charge eliminating voltage or the second charge eliminating voltage) in two digits, and buttons (+ button and - button) to increase or decrease the value of the charge eliminating voltage. Upon pressing the + button, a number in a corresponding digit is increased, and upon pressing the - button, the number in the corresponding digit is decreased.

The value displayed in the display portion is a value in which an absolute value of the charge eliminating voltage is displayed by a two-digit number in a unit of 0.1 kV. In other words, a value obtained by multiplying the value, which is displayed in the display portion of the voltage adjusting switches 54b and 54c, by -0.1 kV is the setting value for the charge eliminating voltage. For example, in a case in which "45" is displayed in the display portion of the voltage adjusting switch 54b, the setting value for the first charge eliminating voltage is -4.5 kV. From this state, upon pressing the - button in a tens place once and the + button in a ones place twice, the display becomes "37", and the setting value for the charge elimination voltage is set to -3.7 kV.

Incidentally, in a case in which the displays are set to "00" with the voltage adjusting switches 54b and 54c, the setting values for the charge eliminating voltages are set to 0 V (0.0 kV). In this case, a state of the high voltage power source 55 becomes the same state as when the changeover switch 54a is turned off. This state may also be referred to as a state in which the high voltage power source 55 applies 0 V to the charge eliminating roller 51b.

Incidentally, a display type and an input type of the value of the charge eliminating voltage is not limited to those described above. Instead of displaying upper two digits of the value of the charge eliminating voltage, the value of the charge eliminating voltage as it is may be displayed, or a numerical value which represents a level of the charge eliminating voltage, for example, in 10 levels may be displayed. The value of the charge eliminating voltage may be displayed, for example, on a screen of the user operating portion 102 or of an external computer communicably connected to the image forming system 400. As the input type of the value of the charge eliminating voltage, numeric keypads for numerical input may be provided to the operating portion for charge eliminating 54, or it may be an operation of the touch panel in the user operating portion 102, or it may be configured to receive an input via the external computer. The user operating portion 102 is another example of the input means (setting means) which allows a user to input (set) the value of the voltage to be applied to the charge eliminating roller 51b (charge eliminating member) by the high voltage power source 55 (voltage applying means). Also in the cases in which the value of the charge eliminating voltage is input via the user operating portion 102 or the external computer, it is configured that the two types of voltage values of the first charge eliminating voltage and the second charge eliminating voltage can be set, respectively.

### Automatic setting of the second charge eliminating voltage

In the present Embodiment, it is configured so that when a user inputs the value of the first charge eliminating voltage for the single-side printing, the value of the second charge eliminating voltage for the double-side printing is automatically set. For example, the value of the second charge eliminating voltage is automatically set to a value lower than the value of the first charge eliminating voltage by -1 kV. Incidentally, the user may further change the value of the second charge eliminating voltage, which is automatically set by the apparatus, through the operation of the voltage adjusting switch 54c of the operating portion for charge eliminating 54.

First, the appropriate value for the charge eliminating voltage upon the double-side printing will be described. In the following description, a sheet having a volume resistivity equal to or greater than 1 × 10¹³ Ω cm is referred to as a "high resistance sheet", and a sheet having a volume resistivity less than 1 × 10¹³ Ω cm is referred to as a "low resistance sheet". An example of the high resistance sheet is a synthetic paper, and an example of the low resistance sheet is a plain paper.

In a case of the high resistance sheet, an electrification charge amount when the sheet S, on which the double-side printing has been performed, reaches the charge eliminating nip becomes smaller than the electrification charge amount when the sheet S, on which the single-side printing has been performed, reaches the charge eliminating nip. A reason why the electrification charge amount of the sheet S is different between upon the single-side printing and upon the double-side printing will be described below.

And, as the electrification charge amount of the sheet S at the time when the sheet S reaches the charge eliminating nip gets smaller, an amount of charge which the charge eliminating roller 51b needs to supply to the sheet S for performing the charge eliminating of the sheet S becomes smaller. In other words, in the case of the high resistance sheet, the appropriate value for the charge eliminating voltage upon the double-side printing (second charge eliminating voltage) becomes a value smaller in absolute value than the appropriate value for the charge eliminating voltage upon the single-side printing (the first charge eliminating voltage).

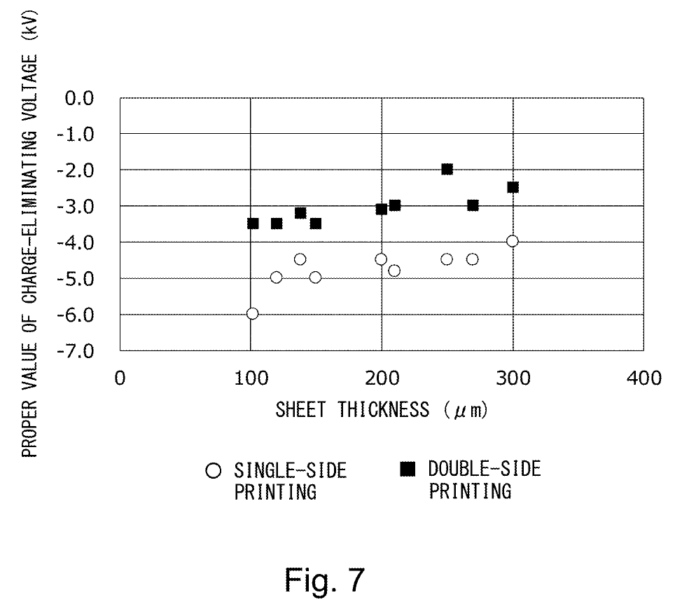

In FIG. 7, examples of the appropriate value for the charge eliminating voltage for the high resistance sheet are shown. Data in FIG. 7 shows results for a plurality of types of synthetic papers having a volume resistivity of 1 × 10¹³ through 1 × 10¹⁴ Ω cm. A horizontal axis represents a thickness of the synthetic paper. A vertical axis represents the appropriate value for the charge eliminating voltage (first charge eliminating voltage, second charge eliminating voltage) when the single-side printing or the double-side printing is performed on each sheet under a preset condition and the charge of each sheet is eliminated by the charge eliminating roller 51b.

As it can be seen from FIG. 7, in any of the high resistance sheets having different thicknesses, the appropriate values for the charge eliminating voltage upon the double-side printing (second charge eliminating voltage) is lower compared to the appropriate value for the charge eliminating voltage upon the single-side printing (first charge eliminating voltage). In other words, the appropriate value for the charge eliminating voltage for the sheet of which the images have been formed on both sides is lower (smaller in absolute value) than the appropriate value for the charge eliminating voltage for the sheet of which the image has been formed only on one side.

Therefore, it is preferable that the value for the second charge eliminating voltage be lower (smaller in absolute value) than the value for the first charge eliminating voltage. This is because, if the value of the second charge eliminating voltage is equal to the first charge eliminating voltage, the second charge eliminating voltage becomes a value greater than the appropriate value for the charge eliminating voltage, so that excessive charge is supplied to the sheet S to cause a charge eliminating defect (charged to an opposite polarity to that before passing through the charge eliminating nip), and sticking between the sheets S becomes likely to occur. In addition, for example, in the case in which the plurality of levels of the charge eliminating voltages are set correspondingly to the thicknesses of the sheets, it is preferable that, for each sheet having different thicknesses, the setting value for the second charge eliminating voltage be set to a value lower (smaller in absolute value) than the setting value for the first charge eliminating voltage.

Thus, in the present Embodiment, it is configured that a control means for the charge eliminating apparatus 300 is capable of automatically setting the value of the charge eliminating voltage upon the double-side printing (second charge eliminating voltage, second voltage) to a value different from the charge eliminating voltage upon the single-side printing (first charge eliminating voltage, first voltage). More specifically, in the present Embodiment, in a case in which the first charge eliminating voltage is set through the operating portion for charge eliminating 54, the value of the second charge eliminating voltage is automatically set to a value having the same polarity as the first charge eliminating voltage and smaller in absolute value than the first charge eliminating voltage. “Automatically” means that, in a state in which a user has not input a value different from the first charge eliminating voltage as the value of the second charge eliminating voltage, based on determination by the control means, the second charge eliminating voltage is set to a value different from the first charge eliminating voltage.

### Control circuit

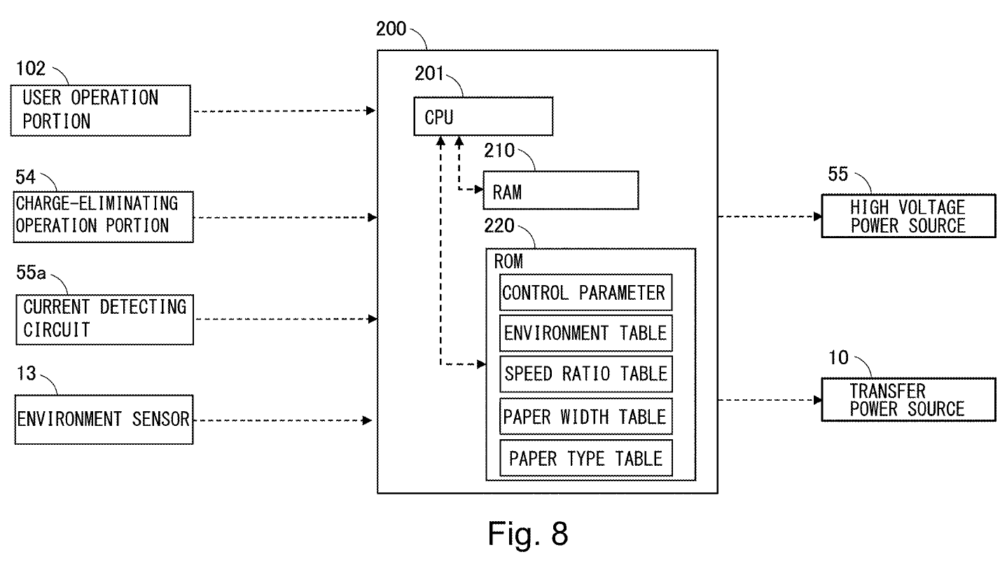

In FIG. 8, a block diagram of a control circuit 200 on control of the charge eliminating voltage is illustrated. The control circuit 200 is an example of a control means which controls the operation of the charge eliminating apparatus 300. The control circuit 200 may be mounted in a main assembly of the charge eliminating apparatus 300, or a part or all of functions of the control circuit 200 may be installed in the image forming apparatus 100.

As shown in FIG. 8, the control circuit 200 includes a CPU 201, a RAM 210, and a ROM 220. The CPU 201 is an executing means which reads out and executes control programs. The RAM 210 provides a working area upon the CPU 201 executing the control programs. The ROM 220 is an example of a storage portion which stores various types of information such as setting information on the control of the charge eliminating apparatus 300. In addition, the control circuit 200 is connected to the user operating portion 102, the operating portion for charge eliminating 54, the high voltage power source 55, and the transfer power source 10.

The CPU 201 acquires information such as information on the image forming job (job information), the settings for the charge eliminating voltage, and a value of the transfer voltage which the transfer power source 10 outputs, and stores the information in the RAM 210. Here, the job information is, for example, attribute information of the sheet S, which is input from a user via the user operating portion 102 and is the attribute information of the sheet S which is used for a current image forming job. The settings for the charge eliminating voltage are the values of the first charge eliminating voltage and the second charge eliminating voltage set by a user through the operation of the operating portion for charge eliminating 54. In addition, in the ROM 220, control parameters and various types of tables used for the control of the charge eliminating voltage are stored.

Incidentally, the control circuit 200 is connected to an environment sensor 13 for detecting the environment condition of the installed environment (a space surrounding the installed apparatus) of the charge eliminating apparatus 300 (image forming system 400). In addition, the control circuit 200 may acquire, based on a detection result of a current detecting circuit 55a provided inside the high voltage power source 55, a current value (charge eliminating current) which has flowed to the charge eliminating roller 51b.

### Control flow

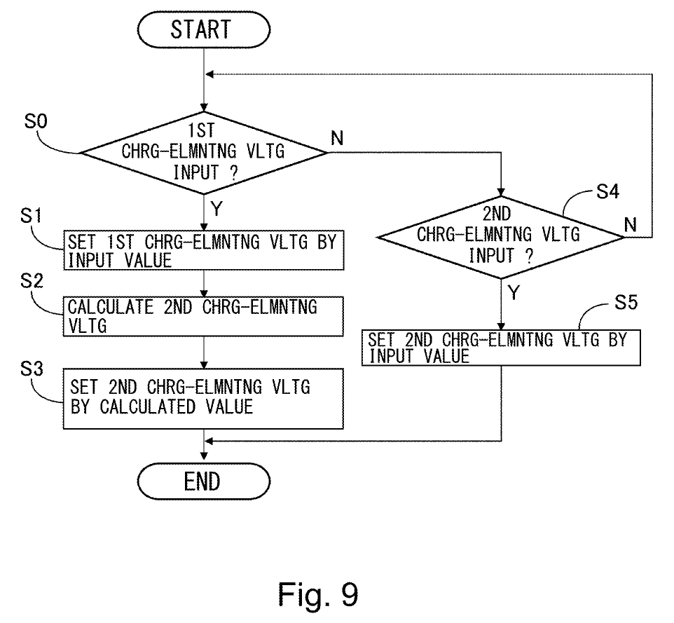

A procedure for the control of the charge eliminating voltage performed by the control circuit 200 will be described along a flowchart in FIG. 9. Hereinafter, an executing entity for each step in the present flow is, unless otherwise specified, the CPU 201. In addition, the present flow is continuously executed while a user can set the value of the first charge eliminating voltage through the operating portion for charge eliminating 54.

When the user inputs the value of the first charge eliminating voltage through the operation of the operating portion for charge eliminating 54 (Y in S0), the CPU 201 stores the input value in the RAM 210, and resets the value of the first charge eliminating voltage (S1). In addition, the CPU 201 calculates, based on the first charge eliminating voltage after resetting, the value of the second charge eliminating voltage through a method set in advance (S2), stores the calculated value in the RAM 210, and resets the value of the second charge eliminating voltage (S3). In other words, the control circuit 200 (control means) automatically sets the value of the second charge eliminating voltage (value of the second voltage) based on the value of the first charge eliminating voltage (value of the first voltage) input via the operating portion for charge eliminating 54 (input portion).

The method set in advance is, for example, a table defining a corresponding relationship between the value of the first charge eliminating voltage and the value of the second charge eliminating voltage, and in this case it is assumed that results obtained through a prior study are stored in the ROM 220. In addition, a converting method may be a function for obtaining the value of the second charge eliminating voltage using the value of the first charge eliminating voltage as a variable. In this case, coefficients and constants of the function are obtained through a prior study, and are stored in the ROM 220 as the control parameters.

As a result of the control described above, when the double-side printing job is submitted after the operation to input the first charge eliminating voltage is performed in the operating portion for charge eliminating 54, the CPU 201 causes the second charge eliminating voltage to be applied from the high voltage power source 55 to the charge eliminating roller 51b at the value of the second charge eliminating voltage which is automatically set. By this, in the case in which the appropriate values for the charge eliminating voltage are different between upon the double-side printing and upon the single-side printing, it becomes possible to automatically apply the charge eliminating voltage having a value suitable for the sheet on which the double-side printing has been performed.

In addition, according to the present Embodiment, compared to a case in which a user inputs the first charge eliminating voltage and the second charge eliminating voltage individually, it becomes possible to simplify the input operation, thereby improving usability.

On the other hand, when the user inputs the value of the second charge eliminating voltage through the operation of the operating portion for charge eliminating 54 (N in S0 → Y in S4), the CPU 201 stores the input value in the RAM 210, and resets the value of the second charge eliminating voltage (S5). In other words, when the value of the second charge eliminating voltage is input via the operating portion for charge eliminating 54 (input portion) after the control circuit 200 (control means) automatically sets the value of the second charge eliminating voltage (second voltage), the control circuit 200 resets the second charge eliminating voltage to the input value.

Therefore, even in the case in which the value of the second charge eliminating voltage is automatically set based on the input value of the first charge eliminating voltage, it becomes possible for a user to further change the value of the second charge eliminating voltage optionally.

### Reason why the difference in the electrification charge amount is generated

As to the high resistance sheet, the reason why the difference in the electrification charge amount of the sheet S is generated between upon the single-side printing and upon the double-side printing will be described. In the following, the surface of the sheet S on which the image is formed upon the single-side printing and the surface of the sheet S on which the image is formed first upon the double-side printing are referred to as a "front surface Sf", and the surface of the sheet S on the opposite side thereof (surface on which the image is formed later upon the double-side printing) is referred to as a "back surface Sr". On the other hand, the surface of the sheet S which contacts the charge eliminating opposing roller 51a upon passing through the charge eliminating nip is referred to as the "first surface Sa", and the surface of the sheet S which contacts the charge eliminating roller 51b is referred to as the "second surface Sb", which are distinguished from the front surface Sf and the back surface Sr.

In common to the single-side printing and the double-side printing, the sheet S receives an effect of the bias electric field in the secondary transfer portion T2. The bias electric field is formed so that the potential on the secondary transfer roller 9 (an outside roller) side becomes the same polarity as the opposite polarity to the normal charging polarity of the toner with respect to a potential on the opposite roller 21 (an inside roller) side. Hereinafter, for the sake of description, it is assumed that the normal charging polarity of the toner is negative polarity. As described above, by the electrostatic force generated by the bias electric field acting on the charged toner, the toner is transferred from the intermediary transfer belt 6 to the sheet S, and the transfer of the toner image is performed.

In the case in which the sheet S is the high resistance sheet, upon the sheet S passing through the secondary transfer portion T2, while positive charge is supplied from the secondary transfer roller 9 to one surface of the sheet S (the surface contacting the secondary transfer roller 9), negative charge is generated on the other surface of the sheet S by dielectric polarization. As a result, the both sides of the sheet S become a charged state. Since the sheet S has high resistance, the electrification charge amount is not easily attenuated even after exiting the secondary transfer portion T2.

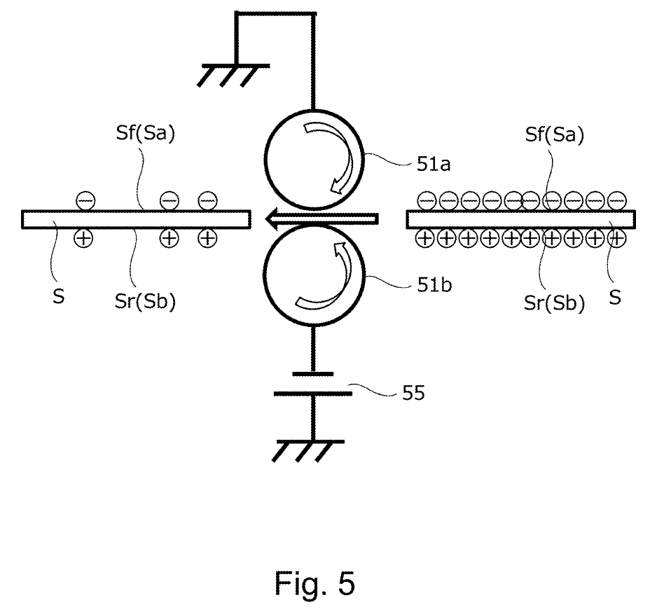

Therefore, in the case in which the single-side printing is performed to the high resistance sheet, as shown in FIG. 5, the sheet S reaches the charge eliminating nip in a state in which the front surface Sf (first surface Sa) is charged to negative polarity and the back surface Sr (second surface Sb) is charged to positive polarity, and the electrification charge amounts thereof are large. In the charge eliminating nip, so as a current in an opposite direction to the current during transfer to flow (in other words, so as to supply the negative charge to the back surface Sr of the sheet S), the first charge eliminating voltage is applied to the charge eliminating roller 51b. The charge remaining on each surface of the sheet S even after passing through the charge eliminating nip is further eliminated by the ionizer portion 52 (FIG. 2) in the present Embodiment.

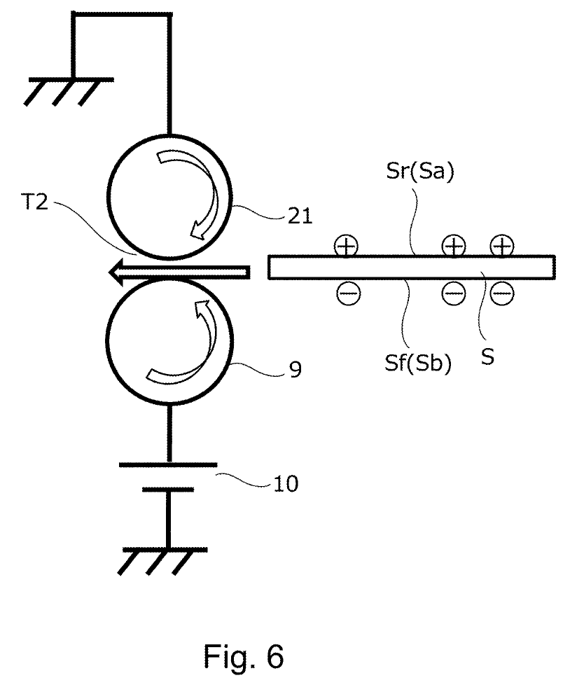

On the other hand, in the case in which the double-side printing is performed to the high resistance sheet, for the same reason as upon the single-side printing, the front surface Sf (first surface Sa) of the sheet S is charged to the negative polarity and the back surface Sr (second surface Sb) is charged to the positive polarity at the time of the toner image transfer onto the front surface Sf (during front surface transfer). Since the sheet S has high resistance, the attenuation of the electrification charge amount while being conveyed via the reversing portion 43 and the double-side conveyance portion 44 is relatively small. Therefore, as shown in FIG. 6, when the toner image is transferred onto the back surface Sr of the sheet S (during back surface transfer), the sheet S enters the secondary transfer portion T2 in a state in which the surface charge of the sheet S remains.

Here, between during front surface transfer and during back surface transfer, the front surface Sf and the back surface Sr of the sheet S are reversed. Therefore, immediately before the back surface transfer, in the sheet S, the positive charge remains on the back surface Sr (first surface Sa), which faces the intermediary transfer belt 6, and the negative charge remains on the front surface Sf (second surface Sb), which faces the secondary transfer roller 9. On the other hand, in the secondary transfer portion T2, the positive charge is supplied from the secondary transfer roller 9 to the front surface Sf (second surface Sb) of the sheet S.

Therefore, a part of the positive charge supplied from the secondary transfer roller 9 to the front surface Sf of the sheet S during back surface transfer is consumed (neutralized) in a manner of cancelling the negative charge of the front surface Sf of the sheet S, which has been generated upon the front surface transfer and remains until upon the back surface transfer. On the other hand, a magnitude of the transfer current (current flowing from the secondary transfer roller 9 to the sheet S) for obtaining good transfer performance is basically the same between during single-side printing and during front surface transfer and during back surface transfer in the double-side printing. As a result, in the case of the high resistance sheet, the electrification charge amount of the sheet S immediately after the toner image transfer onto the back surface Sr in the double-side printing becomes smaller than the electrification charge amount of the sheet S immediately after the toner image transfer in the single-side printing. Thus, in the case of the high resistance sheet, the electrification charge amount when the sheet S, on which the double-side printing has been performed, reaches the charge eliminating nip becomes smaller than the electrification charge amount when the sheet S, on which the single-side printing has been performed, reaches the charge eliminating nip.

Incidentally, in the case of the high resistance sheet, the transfer voltage during back surface transfer is set lower than the transfer voltage upon the single-side printing. For example, if the transfer voltage upon the single-side printing is +5 kV for the high resistance sheet, then the transfer voltage during back surface transfer in the double-side printing is set to about +4 kV. This is because the surface charge of the sheet S generated during front surface transfer acts in a direction of strengthening the bias electric field in the secondary transfer portion T2 during back surface transfer. In other words, in order to make the strength of the bias electric field the same between during front surface transfer and during back surface transfer, it is sufficient that the transfer voltage during back surface transfer is set lower than that during front surface transfer.

### Difference caused by the sheet type

In the above description, the case in which the high resistance sheet such as the synthetic paper is used has been described, however, there is a case in which a different behavior is exhibited in a case of the low resistance sheet.

In the case of the low resistance sheet, the dielectric polarization is less likely to occur, and most of the charge supplied from the secondary transfer roller 9 passes through the sheet in a thickness direction. Therefore, the electrification charge amount of the sheet S immediately after passing through the secondary transfer portion T2 is relatively small. In addition, by the sheet S, which has passed through the secondary transfer portion T2 for a first time, being rubbed against the conveyance guide, which is in the grounded state, while being conveyed by the reversing portion 43 and the double-side conveyance portion 44 (FIG. 1), the electrification charge amount of the sheet S is attenuated. Therefore, the negative charge on the front surface Sf of the sheet S, which has been generated upon the front surface transfer and remains until upon the back surface transfer, is less, so that the positive charge supplied from the secondary transfer roller 9 to the sheet S during back surface transfer is less likely to be cancelled. Furthermore, in common between upon the single-side printing and upon the double-side printing, in a process from when the sheet S passes through the secondary transfer portion T2 until when the sheet S is conveyed to the charge eliminating nip, by the sheet S being rubbed against the conveyance guide, etc., which are grounded, the electrification charge amount of the sheet S is further attenuated.

As a result, in the low resistance sheet, it is often a case that there is no large difference in the electrification charge amount of the sheet S at the time of reaching the charge eliminating nip between upon the single-side printing and upon the double-side printing. In this case, the second charge eliminating voltage may be the same value as the first charge eliminating voltage. In a case in which the electrification charge amount of the sheet S is of a degree which does not cause inconvenience such as the sticking between the sheets, both the first charge eliminating voltage and the second charge eliminating voltage may be set to 0 V.

In other words, depending on the type of the sheet S, a magnitude relationship of the absolute value of the second charge eliminating voltage with respect to the absolute value of the first charge eliminating voltage may be changed. Specifically, for the high resistance sheet (for example, the synthetic paper), the second charge eliminating voltage is automatically set to a value smaller in absolute value than the first charge eliminating voltage. On the other hand, for the low resistance sheet (for example, the plain paper), the second charge eliminating voltage is automatically set to the same value as the first charge eliminating voltage.

As a result, upon automatically setting the value of the second charge eliminating voltage, it becomes possible to set a more appropriate value depending on the type of the sheet S.

Incidentally, the fact that the transfer voltage during back surface transfer becomes lower than the transfer voltage upon the single-side printing in the case of the high resistance sheet is described, however, in the case of the low resistance sheet, there is a case in which the transfer voltage during back surface transfer rather becomes higher than the transfer voltage upon the single-side printing. For example, this is a case in which by a liquid content of the sheet S being lowered by the heat in the fixing device 40, a resistance value of the sheet S during back surface transfer becomes higher than that during front surface transfer. In addition, when the transfer voltage during back surface transfer is set higher than the transfer voltage during front surface transfer is a case in which, for example, by the toner having a higher resistance than the material of the sheet S being adhered to the surface of the sheet S, the resistance value of the sheet S during back surface transfer becomes higher than that during front surface transfer.

In other words, in the low resistance sheet, there is a case in which the electrification charge amount of the sheet S upon the double-side printing becomes greater than the electrification charge amount of the sheet S upon the single-side printing. Therefore, for the low resistance sheet, the second charge eliminating voltage may be set to a value greater in absolute value than the first charge eliminating voltage.

### Embodiment 2

An Embodiment 2 will be described. Hereinafter, it is assumed that elements, to which the same reference numerals as those in the Embodiment 1 are given, basically have the same configurations and actions as those described in the Embodiment 1 unless otherwise described, and portions different from the Embodiment 1 will be mainly described.

A control circuit 200 in the present Embodiment is capable of executing a mode (adjusting mode) which performs adjustment of a charge eliminating voltage. A configuration of the control circuit 200 may be the same as that in the Embodiment 1 (FIG. 8).

The adjusting mode is executed in a case in which a value of the charge eliminating voltage which is to be applied to the charge eliminating roller 51b for performing the charge eliminating of the sheet S, which is used for an image forming job, is unknown. For example, in a case in which the image forming job is submitted, the adjusting mode is automatically executed before an image is formed on the sheet S, which is to be a product. Alternatively, the adjusting mode may be executed, as a job independent of the image forming job, based on an operation of a user operating portion 102 by a user.

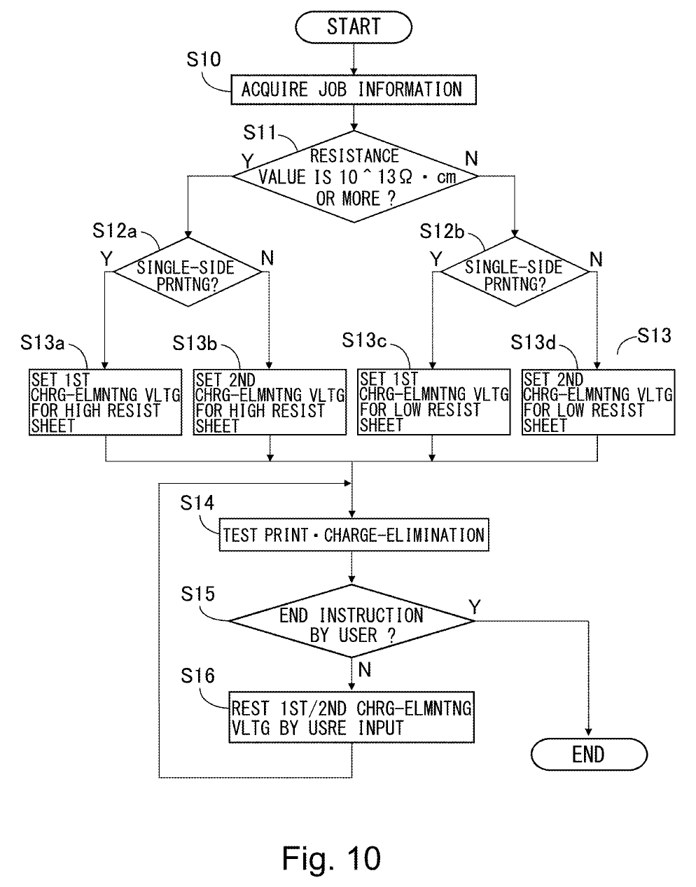

Hereinafter, a procedure of control performed by the control circuit 200 will be described along a flowchart in FIG. 10. Hereinafter, an executing entity for each step in the present flow is, unless otherwise specified, a CPU 201.

When the adjusting mode is started, the CPU 201 acquires a sheet information included in a job information (S10). The sheet information is attribute information such as a type (material and thickness), a size, and a brand of the sheet S, which is used for a current job, and is set in advance via the user operating portion 102, etc. The CPU 201 determines, based on the sheet information, whether the sheet S is a high resistance sheet or a low resistance sheet (S11). In the present Embodiment, with a resistance value (volume resistivity) of 1× 10¹³ Ω cm as a threshold value, the CPU 201 determines that the sheet is the high resistance sheet if the resistance value is equal to or greater than the threshold value, and the CPU 201 determines that the sheet is the low resistance sheet if the resistance value is less than the threshold value.

Furthermore, the CPU 201 determines whether a mode of the image forming operation in the current job is the single-side printing or the double-side printing (S12a, S12b), and sets the value of the charge eliminating voltage in accordance with a result thereof. In other words, the control circuit 200 (control means) automatically sets the value of the first charge eliminating voltage (first voltage) and the value of the second charge eliminating voltage (second voltage) based on the sheet information on the sheet and information indicating whether the image is formed only on one side of the sheet or on both sides of the sheet.

In a case of the high resistance sheet and the single-side printing, the CPU 201 determines a setting value for the charge eliminating voltage, which is used for the current job, to a value of the first charge eliminating voltage for the high resistance sheet (S13a). In a case of the high resistance sheet and the double-side printing, the CPU 201 determines the setting value for the charge eliminating voltage, which is used for the current job, to a value of the second charge eliminating voltage for the high resistance sheet (S13b). In a case of the low resistance sheet and the single-side printing, the CPU 201 determines the setting value for the charge eliminating voltage, which is used for the current job, to a value of the first charge eliminating voltage for the low resistance sheet (S13c). In a case of the low resistance sheet and the double-side printing, the CPU 201 determines the setting value for the charge eliminating voltage, which is used for the current job, to a value of the second charge eliminating voltage for the low resistance sheet (S13d).

The first charge eliminating voltage and the second charge eliminating voltage for the high resistance sheet and the first charge eliminating voltage and the second charge eliminating voltage for the low resistance sheet described above may be values set in advance in a form of a table corresponding to the sheet information (paper type table in FIG. 8) and stored in the ROM 220, for example. In addition, as for the values of the respective charge eliminating voltages described above, in a case in which the value of any of the charge eliminating voltages is input from a user through the operation of the operating portion for charge eliminating 54, etc., the input value may be used. In addition, the values of the respective charge eliminating voltages described above may be values which are set to different values depending on other conditions such as environment conditions detected by an environment sensor 13 (for example, temperature and/or humidity).

Comparing in the cases of the high resistance sheet, the second charge eliminating voltage is set to a value smaller in absolute value than the value of the first charge eliminating voltage. As an example, the second charge eliminating voltage is set to a voltage lower than the first charge eliminating voltage by 1 kV. In addition, comparing in the cases of the low resistance sheet, the second charge eliminating voltage is set to the same value as the value of the first charge eliminating voltage, or a value greater in absolute value than the first charge eliminating voltage.

Next, the CPU 201 causes the image forming apparatus 100 to execute the double-side printing, and causes the charge eliminating apparatus 300 to eliminate the charge of the sheet S (S14) using the second charge eliminating voltage set in S13b or S13d. At this time, to the secondary transfer roller 9, a transfer voltage is applied at the same voltage value as that of a normal image forming job.

A user measures an electrification charge amount of the discharged sheet S using a surface potential sensor, etc., and if the user determines that an adjustment of the charge eliminating voltage is needed, then the user inputs the value of the second charge eliminating voltage to the operating portion for charge eliminating 54 (N in S15). In this case, the CPU 201 resets the second charge eliminating voltage with the value input by the user (S16), and returns the process to S14 to continue the adjusting mode. On the other hand, as a result of the measurement, if the user determines that the charge of the sheet S is sufficiently eliminated, then the user instructs completion of the adjusting mode via the user operating portion 102 (Y in S15), and the CPU 201 terminates the adjusting mode. Incidentally, after the termination of the adjusting mode, a double-side printing job may be continuously started.

Also in the present Embodiment, the control means of the charge eliminating apparatus 300 automatically sets the value of the charge eliminating voltage upon the double-side printing (second charge eliminating voltage, second voltage) to a value different from the charge eliminating voltage upon the single-side printing (first charge eliminating voltage, first voltage). By this, in the case in which the appropriate values for the charge eliminating voltage are different between upon the double-side printing and upon the single-side printing, it becomes possible to automatically apply the charge eliminating voltage having a value more suitable for the sheet on which the double-side printing has been performed.

In addition, according to the present Embodiment, it becomes possible to start, with the first charge eliminating voltage or the second charge eliminating voltage, which is automatically set by the control means, as a starting point, the adjustment of the first charge eliminating voltage or the second charge eliminating voltage. Therefore, it becomes possible to reduce a load of an adjusting work for the first charge eliminating voltage and/or the second charge eliminating voltage.

### Other Embodiments

In each of the Embodiments described above, the charge eliminating apparatus 300 performing the charge eliminating of the sheet S has been described, however, the charge eliminating apparatus 300 has the function as a charge adjusting apparatus, which adjusts, by supplying a charge to the sheet S via the charge eliminating roller 51b as a charge applying member, the charged state of the sheet S. The charge adjusting apparatus may be an apparatus which does not necessarily reduce (eliminate) the electrification charge amount of the sheet S. For example, the charge adjusting apparatus may be an apparatus which adjusts, in a state in which the sheets S are stacked after the processing by the charge adjusting apparatus, the electrification charge amount of each surface of the sheet S so as to realize a state in which the surfaces of stacked sheets opposite to each other are charged to the same polarity. Specifically, the charge adjusting apparatus applies, every other sheet of a plurality of the sheets, voltage so as electrostatic polarities of the sheet surfaces to be reversed. In this case, by the surfaces of the stacked sheets opposite to each other being charged to the same polarity, it becomes possible to reduce the sticking between the sheets due to electrostatic force. In addition, by applying the control described in each of the Embodiments to the control of the voltage to be applied to the charge eliminating roller 51b as the charge supplying member, it becomes possible to adjust the charged state of the sheet S more appropriately.

In addition, in each of the Embodiments described above, as an example of the charge eliminating member of contact type, which contacts the sheet S, the charge eliminating roller 51b, which is a roller member, has been described. However, the charge eliminating member of contact type is not limited thereto, but may be, for example, a brush member in which electroconductive fibers or an elongated electroconductive sheet pieces thereof contacts the sheet S.

In addition, in each of the Embodiments described above, the setting method for the voltage to be applied to the charge eliminating roller 51b, which is the charge eliminating member of contact type has been mainly described, however, it is not limited thereto, but the setting method for the voltage to be applied which has been described in each of the Embodiments may be applied to a charge eliminating member of non-contact type. For example, in a case in which a charge eliminator of corotron type or scorotron type is used instead of the charge eliminating roller 51b, the present technology may be applied to control of a voltage to be applied to a discharging wire as a charge eliminating member.

In addition, in each of the Embodiments described above, it has been described as the charge of the sheet S is generated mainly in the transfer portion in the electrophotographic process. Not limited thereto, however, in an image forming system other than the electrophotographic type such as an inkjet type, the charge of the sheet S may be generated by triboelectric charging or peeling charging due to rubbing against and/or peeling off of a conveyance guide, a conveyance roller, a conveyance belt, etc. Therefore, the present technology may be applied to an image forming system of a type other than the electrophotographic type.

### Other Embodiments

The present invention may also be realized by a process in which a program realizing one or more functions in the Embodiments described above are supplied to the system or the apparatus via a network or a storage medium, and one or more processors in a computer of the system or the apparatus read out and execute the program. In addition, the present invention may also be realized by a circuit which realizes the one or more functions (e.g., ASIC).

### INDUSTRIAL APPLICABILITY

According to the present invention, the charge eliminating apparatus which eliminates the charge of the sheet, the image forming system which forms the image on the sheet, and the charge adjusting apparatus which adjusts the charged state of the sheet are provided.

The present invention is not limited to the Embodiments described above, and various changes and modifications may be made without departing from the spirit and scope of the present invention. Therefore, the following claims are attached in order to make the scope of the present invention public.

The present application claims priority on the basis of Japanese Patent Application NO. 2023-212350 filed on Dec. 15, 2023, which is hereby incorporated by reference herein in its entirety.

1. A charge eliminating apparatus comprising:
a charge eliminating member configured to eliminate charge of a sheet;
a voltage applying portion configured to apply a voltage to the charge eliminating member; and
a controller configured such that, when the charge of the sheet on which an image is formed only on one side is eliminated, the voltage applied by the voltage applying portion to the charge eliminating member is a first voltage, and when the charge of the sheet on which images are formed on both sides is eliminated, the voltage applied by the voltage applying portion to the charge eliminating member is a second voltage, the controller sets a value of the second voltage to be different from a value of the first voltage.

2. The charge eliminating apparatus according to claim 1, wherein the controller sets the value of the second voltage to be smaller in absolute value than the value of the first voltage.

3. The charge eliminating apparatus according to claim 1, wherein the controller sets the value of the second voltage to be smaller in absolute value than the value of the first voltage when the charge of a synthetic paper is eliminated, and sets the value of the second voltage to be a value that is equal to the value of the first voltage or greater in absolute value than the value of the first voltage when the charge of a plain paper is eliminated.

4. The charge eliminating apparatus according to claim 1, wherein the controller sets the value of the second voltage to be smaller in absolute value than the value of the first voltage when the charge of a sheet having a volume resistivity equal to or greater than a threshold value is eliminated, and sets the value of the second voltage to be a value that is equal to the value of the first voltage or greater in absolute value than the value of the first voltage when the charge of a sheet having a volume resistivity less than the threshold value is eliminated.

5. The charge eliminating apparatus according to claim 1, further comprising an input portion configured to allow a user to input the value of the first voltage,
wherein the controller sets the value of the second voltage based on the value of the first voltage when the value of the first voltage is input via the input portion.

6. The charge eliminating apparatus according to claim 5, wherein the input portion is configured to allow the user to input the value of the second voltage,
wherein the controller resets the value of the second voltage the input value when the value of the second voltage is input via the input portion after the value of the second voltage has been set.

7. The charge eliminating apparatus according to claim 1, wherein the controller sets the value of the first voltage and the value of the second voltage based on sheet information on the sheet and information indicating whether the image is formed on only one side of the sheet or on both sides of the sheet.

8. The charge eliminating apparatus according to claim 7, wherein the controller, when a job for eliminating the charge of the sheet by charge eliminating member is submitted, acquires the sheet information of the sheet used in the job and sets the value of the first voltage or the value of the second voltage to be used in the job.

9. The charge eliminating apparatus according to claim 7, wherein the charge eliminating member is disposed so as to contact the sheet to be conveyed.

10. The charge eliminating apparatus according to claim 9, further comprising an opposing roller opposed to the charge eliminating member,
wherein the charge eliminating member is a roller member which forms a nip portion for nipping the sheet with the opposing roller.

11. The charge eliminating apparatus according to claim 9, wherein the voltage applying portion applies a direct current to the charge eliminating member.

12. An image forming system comprising:
an image forming apparatus configured to form an image onto a sheet; and
a charge eliminating apparatus according to claim 1, the charge eliminating apparatus eliminates charge of the sheet on which the image is formed by the image forming apparatus.

13. A charge adjusting apparatus comprising:
a charge supplying member configured to supply charge to a sheet;
a voltage applying portion configured to apply a voltage to the charge supplying member; and
a controller configured such that, when a charged state of the sheet on which an image is formed only on one side is adjusted, the voltage applied by the voltage applying portion to the charge supplying member is a first voltage, and when the charged state of the sheet on which images are formed on both sides is adjusted, the voltage applied by the voltage applying portion to the charge supplying member is a second voltage, the controller sets a value of the second voltage to be different from a value of the first voltage.
